(19) United States
(12) Patent Application Publication
(10) Pub. No.: US 2019/0322114 A1
(43) Pub. Date: Oct. 24, 2019

(54) MULTI-LAYER BLANKET

(71) Applicant: Xerox Corporation, Norwalk, CT (US)

(72) Inventors: Varun Sambhy, Pittsford, NY (US); Amy C. Porter, Rochester, NY (US); Lin Ma, Pittsford, NY (US); Kyle B. Tallman, Perry, NY (US); Santokh S. Badesha, Pittsford, NY (US); Michael S. Roetker, Webster, NY (US)

(21) Appl. No.: 15/959,856

(22) Filed: Apr. 23, 2018

(51) Int. Cl. B41N 10/04; B41J 2/005; B41F 3/30; B32B 27/08; B32B 27/28; B32B 27/20

(52) U.S. Cl. CPC B41N 10/04; B41J 2/0057; B41F 3/30; B32B 27/08; C08L 83/08; B32B 27/281; B32B 27/20; B41N 2210/14; B32B 27/283

(57) ABSTRACT

The present teachings include a transfer member, a multilayer imaging blanket and a variable data lithography system. The transfer member includes a fluorosilicone surface layer. The surface layer includes mixing a first part and a second part. The first part includes a vinyl terminated trifluoropropyl methylsiloxane, an IR absorbing filler, silica and a first solvent. The second part includes an organo platinum complex having vinyl groups, a methyl hydrosiloxanetrifluoropropyl methyl siloxane having hydrosilane groups an inhibitor and a second solvent. The molar ratio of vinyl groups to hydrosilane groups is 0.7:1.0 to about 1.3:1.0 in the mixture. The mixture of the first part and second is coated on a substrate to form the fluorosilicone surface layer.

### BACKGROUND

### Field of Use

The disclosure relates to marking and printing systems, and more specifically to an image transfer element of such a system.

### Background

Offset lithography is a common method of printing today. For the purposes hereof, the terms “printing” and “marking” are interchangeable. In a typical lithographic process, an image transfer element or imaging plate, which may be a flat plate-like structure, the surface of a cylinder, or belt, etc., is configured to have “image regions” formed of hydrophobic and oleophilic material, and “non-image regions” formed of a hydrophilic material. The image regions are regions corresponding to the areas on the final print (i.e., the target substrate) that are occupied by a printing or marking material such as ink, whereas the non-image regions are the regions corresponding to the areas on the final print that are not occupied by said marking material. The hydrophilic regions accept and are readily wetted by a water-based fluid, commonly referred to as a fountain solution or dampening fluid (typically consisting of water and a small amount of alcohol as well as other additives and/or surfactants to, for example, reduce surface tension). The hydrophobic regions repel fountain solution and accept ink, whereas the fountain solution formed over the hydrophilic regions forms a fluid “release layer” for rejecting ink. Therefore, the hydrophilic regions of the imaging plate correspond to unprinted areas, or “non-image areas,” of the final print.

The ink may be transferred directly to a substrate, such as paper, or may be applied to an intermediate surface, such as an offset (or blanket) cylinder in an offset printing system. In the latter case, the offset cylinder is covered with a conformable coating or sleeve with a surface that can conform to the texture of the substrate, which may have surface peak-to-valley depth somewhat greater than the surface peak-to-valley depth of the imaging blanket. Sufficient pressure is used to transfer the image from the blanket or offset cylinder to the substrate.

The above-described lithographic and offset printing techniques utilize plates which are permanently patterned with the image to be printed (or its negative), and are therefore useful only when printing a large number of copies of the same image (long print runs), such as magazines, newspapers, and the like. These methods do not permit printing a different pattern from one page to the next (referred to herein as variable printing) without removing and replacing the print cylinder and/or the imaging plate (i.e., the technique cannot accommodate true high speed variable printing wherein the image changes from impression to impression, for example, as in the case of digital printing systems).

Efforts have been made to create lithographic and offset printing systems for variable data. One example is disclosed in U.S. Patent Application Publication No. 2012/0103212 A1 (the '212 Publication) published May 3, 2012, and based on U.S. patent application Ser. No. 13/095,714, which is commonly assigned, and the disclosure of which is hereby incorporated by reference herein in its entirety, in which an intense energy source such as a laser is used to pattern-wise evaporate a fountain solution. The '212 publication discloses a family of variable data lithography devices that use a structure to perform both the functions of a traditional imaging plate and of a traditional blanket to retain a patterned fountain solution of dampening fluid for inking, and to delivering that ink pattern to a substrate. A blanket performing both of these functions is referred to herein as an imaging blanket. The imaging blanket retains a fountain solution, requiring that its surface have a selected texture.

Furthermore, the imaging blanket must be thermally absorptive in order to enable rapid evaporation of the fountain solution during patterning. One aspect of thermal absorptivity is the composition of the imaging blanket. Configuring the composition of the imaging blanket to balance thermal absorptivity together with other requirements of the blanket such as texture, durability, affinity to water and oil, and so on presents further opportunities for optimization. Fluoropolymers have been used in a variety of printing systems over the years. For example, fluoropolymers have been used to form the reimageable surface in variable data lithography systems. Fluoropolymers are attractive for their thermal and chemical properties, as well as their release properties when used with specific toner and printing ink materials. Accordingly, there is a need for new fluoropolymer compositions that enable development of new systems for offset printing and/or variable data lithography, as well as for other printing applications.

### SUMMARY

According to various embodiments, there is provided a transfer member for use in a printer. The transfer member includes a fluorosilicone surface layer. The surface layer includes mixing a first part and a second part. The first part includes a vinyl terminated trifluoropropyl methylsiloxane, an IR absorbing filler, silica and a first solvent. The second part includes an organo platinum complex having vinyl groups, a methyl hydrosiloxanetrifluoropropyl methyl siloxane having hydrosilane groups an inhibitor and a second solvent. The molar ratio of vinyl groups to hydrosilane groups is 0.7:1.0 to about 1.3:1.0 in the mixture. The mixture of the first part and second is coated on a substrate to form the fluorosilicone surface layer.

According to various embodiments, there is provided a multilayer imaging blanket for a variable data lithography printing system. The multilayer imaging blanket includes a multilayer base having a lower contacting surface configured to wrap around a printing cylinder of the variable data lithography printing system. The multilayer imaging blanket includes a fluorosilicone surface layer coated and cured about the multilayer base, the fluorosilicone surface layer including a first part and a second part. The first part includes a vinyl terminated trifluoropropyl methylsiloxane, an IR absorbing filler and silica. The second part includes an organo platinum complex having vinyl groups, a methyl hydrosiloxanetrifluoropropyl methyl siloxane having hydrosilane groups and an inhibitor wherein a molar ratio of vinyl groups to hydrosilane groups is from about is 0.7:1.0 to about 1.3:1.0.

A further aspect described herein is a variable data lithography system. The variable data lithography system includes a multilayer imaging blanket. The multilayer imaging blanket includes a multilayer base having a lower contacting surface configured to wrap around a printing cylinder of the variable data lithography printing system, a fluorosilicone surface layer coated about the multilayer base. The fluorosilicone surface layer is coated and cured about the multilayer base. The fluorosilicone surface layer includes a first part and a second part. The first part includes a vinyl terminated trifluoropropyl methylsiloxane, an IR absorbing filler and silica. The second part includes an organo platinum complex having vinyl groups, a methyl hydrosiloxanetrifluoropropyl methyl siloxane having hydrosilane groups and an inhibitor wherein a molar ratio of vinyl groups to hydrosilane groups is is 0.7:1.0 to about 1.3:1.0. There is a primer layer between the multilayer base and the fluorosilicone surface layer. The variable data lithography system includes a fountain solution subsystem configured for applying a layer of fountain solution to the multilayer imaging blanket. The variable data lithography system includes a patterning subsystem configured for selectively removing portions of the fountain solution layer so as to produce a latent image in the fountain solution. The variable data lithography system includes an inking subsystem configured for applying ink over the imaging blanket such that said ink selectively occupies regions of the imaging blanket where fountain solution was removed by the patterning subsystem to thereby produce an inked latent image. The variable data lithography system includes and an image transfer subsystem configured for transferring the inked latent image to a substrate.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a side view of a variable data lithography system according to various embodiments disclosed herein.

FIG. 2 is a side diagrammatical view of a multilayer imaging blanket according to various embodiments disclosed herein.

FIG. 3 is a side diagrammatical view of a multilayer imaging blanket according to various additional embodiments disclosed herein.

It should be noted that some details of the FIGS. have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely illustrative.

Illustrations with respect to one or more implementations, alterations and/or modifications can be made to the illustrated examples without departing from the spirit and scope of the appended claims. In addition, while a particular feature may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

Although embodiments of the disclosure herein are not limited in this regard, the terms “plurality” and “a plurality” as used herein may include, for example, “multiple” or “two or more.” The terms “plurality” or “a plurality” may be used throughout the specification to describe two or more components, devices, elements, units, parameters, or the like. For example, “a plurality of resistors” may include two or more resistors.

The term “silicone” is well understood to those of skill in the relevant art and refers to polyorganosiloxanes having a backbone formed from silicon and oxygen atoms and sidechains containing carbon and hydrogen atoms. For the purposes of this application, the term “silicone” should also be understood to exclude siloxanes that contain fluorine atoms, while the term “fluorosilicone” is used to cover the class of siloxanes that contain fluorine atoms. Other atoms may be present in the silicone rubber, for example nitrogen atoms in amine groups which are used to link siloxane chains together during cross-linking.

The term “fluorosilicone” as used herein refers to polyorganosiloxanes having a backbone formed from silicon and oxygen atoms, and sidechains containing carbon, hydrogen, and fluorine atoms. At least one fluorine atom is present in the sidechain. The sidechains can be linear, branched, cyclic, or aromatic. The fluorosilicone may also contain functional groups, such as amino groups, which permit addition cross-linking. When the cross-linking is complete, such groups become part of the backbone of the overall fluorosilicone. The side chains of the polyorganosiloxane can also be alkyl or aryl. Fluorosilicones are commercially available, for example CFl-3510 from NuSil or SLM (n-27) from Wacker.

The terms “print media”, “print substrate” and “print sheet” generally refers to a usually flexible physical sheet of paper, polymer, Mylar material, plastic, or other suitable physical print media substrate, sheets, webs, etc., for images, whether precut or web fed.

The term “printing device” or “printing system” as used herein refers to a digital copier or printer, scanner, image printing machine, xerographic device, electrostatographic device, digital production press, document processing system, image reproduction machine, bookmaking machine, facsimile machine, multi-function machine, or generally an apparatus useful in performing a print process or the like and can include several marking engines, feed mechanism, scanning assembly as well as other print media processing units, such as paper feeders, finishers, and the like. A “printing system” may handle sheets, webs, substrates, and the like. A printing system can place marks on any surface, and the like, and is any machine that reads marks on input sheets; or any combination of such machines.

As used herein, an “electromagnetic receptor” or “electromagnetic absorbent” is a material which will interact with electromagnetic energy to dissipate the energy such as heat. The applied electromagnetic energy could be used to trigger thermal losses at the receptor through a combination of loss mechanisms.

All physical properties that are defined hereinafter are measured at 20° C. to 25° C. unless otherwise specified. The term “room temperature” refers to 25° C. unless otherwise specified.

While the fluorosilicone composition is discussed herein in relation to ink-based digital offset printing or variable data lithographic printing systems, embodiments of the fluorosilicone composition, or methods of manufacturing imaging members using the same, may be used for other applications, including printing applications other than ink based digital offset printing or variable data lithographic printing systems.

Many of the examples mentioned herein are directed to an imaging blanket (including, for example, a printing sleeve, belt, drum, and the like) that has a uniformly grained and textured blanket surface that is ink-patterned for printing. In a still further example of variable data lithographic printing, such as disclosed in the '212 Publication, a direct central impression printing drum having a low durometer polymer imaging blanket is employed, over which for example, a latent image may be formed and inked. Such a polymer imaging blanket requires, among other parameters, a unique specification of surface roughness, radiation absorptivity, and oleophobicity.

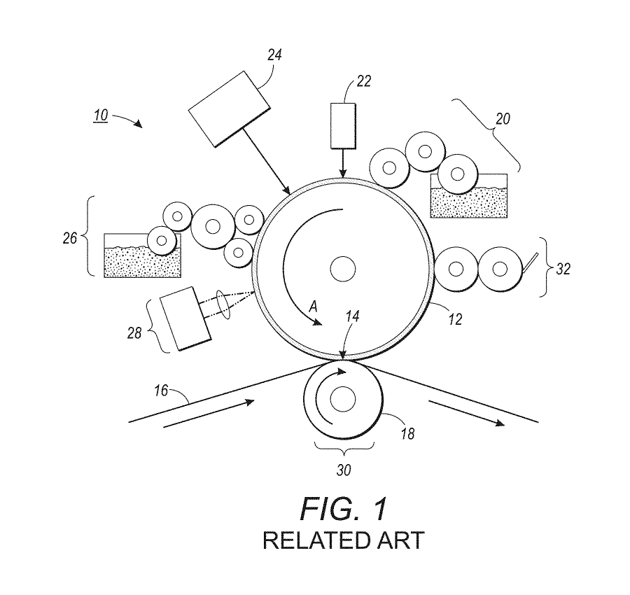

FIG. 1 depicts a variable data lithography printing system 10. A general description of the exemplary system 10 shown in FIG. 1 is provided here. Additional details regarding individual components and/or subsystems shown in the exemplary system 10 of FIG. 1 may be found in the '212 Publication. As shown in FIG. 1, the exemplary system 10 may include an imaging member 12 used to apply an inked image to a target image receiving media substrate 16 at a transfer nip 14. The transfer nip 14 is produced by an impression roller 18, as part of an image transfer mechanism 30, exerting pressure in the direction of the imaging member 12.

The exemplary system 10 may be used for producing images on a wide variety of image receiving media substrates 16. The '212 Publication explains the wide latitude of marking (printing) materials that may be used, including marking materials with pigment densities greater than 10% by weight. Increasing densities of the pigment materials suspended in solution to produce different color inks is generally understood to result in increased image quality and vibrancy. These increased densities, however, often result in precluding the use of such inks in certain image forming applications that are conventionally used to facilitate variable data digital image forming, including, for example, jetted ink image forming applications.

As noted above, the imaging member 12 may include a reimageable surface layer or plate formed over a structural mounting layer that may be, for example, a cylindrical core, or one or more structural layers over a cylindrical core. A fountain solution subsystem 20 may be provided generally comprising a series of rollers, which may be considered as dampening rollers or a dampening unit, for uniformly wetting the reimageable plate surface with a layer of dampening fluid or fountain solution, generally having a uniform thickness, to the reimageable plate surface of the imaging member 12. Once the dampening fluid or fountain solution is metered onto the reimageable surface, a thickness of the layer of dampening fluid or fountain solution may be measured using a sensor 22 that provides feedback to control the metering of the dampening fluid or fountain solution onto the reimageable plate surface.

An optical patterning subsystem 24 may be used to selectively form a latent image in the uniform fountain solution layer by image-wise patterning the fountain solution layer using, for example, laser energy. It is advantageous to form the reimageable plate surface of the imaging member 12 from materials that should ideally absorb most of the IR or laser energy emitted from the optical patterning subsystem 24 close to the reimageable plate surface. Forming the plate surface of such materials may advantageously aid in substantially minimizing energy wasted in heating the fountain solution and coincidentally minimizing lateral spreading of heat in order to maintain a high spatial resolution capability. Briefly, the application of optical patterning energy from the optical patterning subsystem 24 results in selective evaporation of portions of the uniform layer of fountain solution in a manner that produces a latent image.

The patterned layer of fountain solution having a latent image over the reimageable plate surface of the imaging member 12 is then presented or introduced to an inker subsystem 26. The inker subsystem 26 is usable to apply a uniform layer of ink over the patterned layer of fountain solution and the reimageable plate surface of the imaging member 12. In embodiments, the inker subsystem 26 may use an anilox roller to meter an ink onto one or more ink forming rollers that are in contact with the reimageable plate surface of the imaging member 12. In other embodiments, the inker subsystem 26 may include other traditional elements such as a series of metering rollers to provide a precise feed rate of ink to the reimageable plate surface. The inker subsystem 26 may deposit the ink to the areas representing the imaged portions of the reimageable plate surface, while ink deposited on the non-imaged portions of the fountain solution layer will not adhere to those portions.

Cohesiveness and viscosity of the ink residing on the reimageable plate surface may be modified by a number of mechanisms, including through the use of some manner of rheology control subsystem 28. In embodiments, the rheology control subsystem 28 may form a partial cross-linking core of the ink on the reimageable plate surface to, for example, increase ink cohesive strength relative to an adhesive strength of the ink to the reimageable plate surface. In embodiments, certain curing mechanisms may be employed. These curing mechanisms may include, for example, optical or photo curing, heat curing, drying, or various forms of chemical curing. Cooling may be used to modify rheology of the transferred ink as well via multiple physical, mechanical or chemical cooling mechanisms.

Substrate marking occurs as the ink is transferred from the reimageable plate surface to a substrate of image receiving media 16 using the transfer subsystem 30. With the adhesion and/or cohesion of the ink having been modified by the rheology control system 28, modified adhesion and/or cohesion of the ink causes the ink to transfer substantially completely preferentially adhering to the substrate 16 as it separates from the reimageable plate surface of the imaging member 12 at the transfer nip 14. Careful control of the temperature and pressure conditions at the transfer nip 14, combined with reality adjustment of the ink, may allow transfer efficiencies for the ink from the reimageable plate surface of the imaging member 12 to the substrate 16 to exceed 95%. While it is possible that some fountain solution may also wet substrate 16, the volume of such transferred fountain solution will generally be minimal so as to rapidly evaporate or otherwise be absorbed by the substrate 16.

Finally, a cleaning system 32 is provided to remove residual products, including non-transferred residual ink and/or remaining fountain solution from the reimageable plate surface in a manner that is intended to prepare and condition the reimageable plate surface of the imaging member 12 to repeat the above cycle for image transfer in a variable digital data image forming operations in the exemplary system 10. An air knife may be employed to remove residual fountain solution. It is anticipated, however, that some amount of ink residue may remain. Removal of such remaining ink residue may be accomplished through use by some form of cleaning subsystem 32. The cleaning subsystem 32 may include at least a first cleaning member such as a sticky or tacky member in physical contact with the reimageable surface of the imaging member 12, where the sticky or tacky member removes residual ink and any remaining small amounts of surfactant compounds from the fountain solution of the reimageable surface of the imaging member 12. The sticky or tacky member may then be brought into contact with a smooth roller to which residual ink may be transferred from the sticky or tacky member, the ink being subsequently stripped from the smooth roller by, for example, a doctor blade.

Regardless of the cleaning mechanism, however, cleaning of the residual ink and fountain solution from the reimageable surface of the imaging member 12 is essential to prevent a residual image from being printed in the proposed system. Once cleaned, the reimageable surface of the imaging member 12 is again presented to the fountain solution subsystem 20 by which a fresh layer of fountain solution is supplied to the reimageable surface of the imaging member 12, and the process is repeated.

The imaging member 12 plays multiple roles in the variable data lithography printing process, which include: (a) deposition of the fountain solution, (b) creation of the latent image, (c) printing of the ink, and (d) transfer of the ink to the receiving substrate or media. Some desirable qualities for the imaging member 12, particularly its surface, include high tensile strength to increase the useful service lifetime of the imaging member. In some embodiments, the surface layer should also weakly adhere to the ink, yet be wettable with the ink, to promote both uniform inking of image areas and to promote subsequent transfer of the ink from the surface to the receiving substrate. Finally, some solvents have such a low molecular weight that they inevitably cause some swelling of imaging member surface layers. Wear can proceed indirectly under these swell conditions by causing the release of near infrared laser energy absorbing particles at the imaging member surface, which then act as abrasive particles. Accordingly, in some embodiments, the imaging member surface layer has a low tendency to be penetrated by solvent.

In some embodiments, the imaging member surface layer may have a thickness of about 10 microns (μm) to about 1 millimeter (mm), depending on the requirements of the overall printing system. In other embodiments, the imaging member surface layer has a thickness of about 20 μm to about 100 μm. In one embodiment, the thickness of the surface layer is of about 40 μm to about 60 μm.

In some embodiments, the surface layer may have a surface energy of 22 dynes/cm or less with a polar component of 5 dynes/cm or less. In other embodiments, the surface layer has a surface energy of 21 dynes/cm or less with a polar component of 2 dynes/cm or less or a surface energy of 19 dynes/cm or less with a polar component of 1 dyne/cm or less.

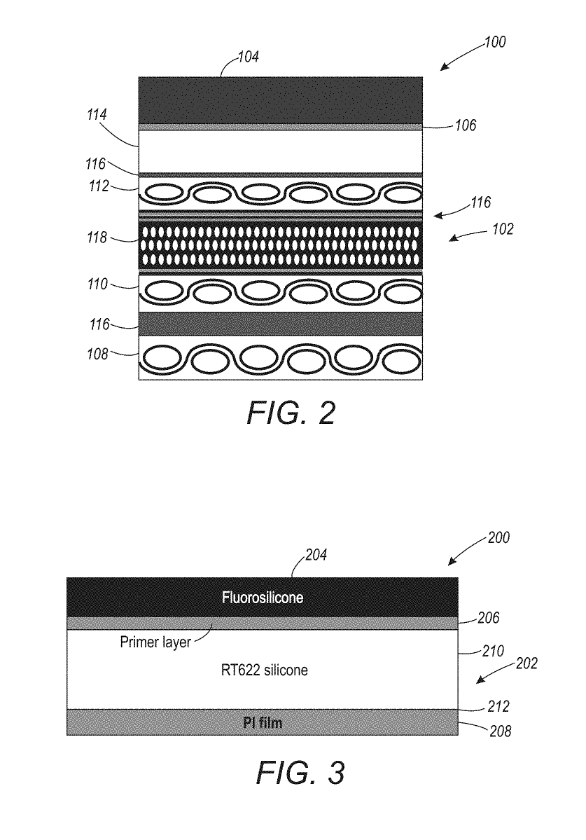

FIG. 2 depicts an imaging blanket for a variable data lithography printing system, according to various embodiments. The imaging blanket is a multilayer blanket 100 having a base 102, a surface layer 104 and a primer layer 106 there between. The base 102 is a carcass at the interior of the imaging blanket intentionally designed to support the surface (e.g., topcoat) layer.

The base 102 may be a multilayer carcass including a bottom fabric layer 108, a center fabric layer 110 on the bottom fabric layer 108, a top fabric layer 112 about the center fabric layer 110, and a top rubber surface 114 above the top fabric layer 112. In addition, the multilayer carcass of the base 102 may include binding layers 116 on opposite sides of the center fabric layer 110, with one of the binding layers 116 coupling the bottom fabric layer 108 and the center fabric layer, and the second one of the binding layers 116 coupling the center fabric layer 110 and the top fabric layer 112. One or both binding layers 116 may include a compressible rubber layer 118.

The bottom fabric layer 108 may be a woven fabric (e.g., cotton, cotton and polyester, polyester) with a lower contacting surface configured to contact directly or indirectly a printing cylinder (not shown) when the multilayer imaging blanket is wrapped around the printing cylinder. The center fabric layer 110 may also be a woven fabric like the bottom fabric layer 108. Both center fabric layer 110 and bottom fabric layer 108 may have a substance value in a range between 150-250 gr/m². The top fabric layer 112 may be made of polyester, polyethylene, polyamide, fiberglass, polypropylene, vinyl, polyphenylene, sulphide, aramids, cotton fiber or any combination thereof, preferably with a thickness value of 35-45 mm and a substance value of 80-90 gr/m².

Each of the binding layers 116 includes an adhesive layer adjacent at least one of the fabric layers 108, 110, 112, that may be made of a polymeric adhesive rubber preferably based on nitrile butadiene rubber. The compressible rubber layer 118 may be made of a polymeric foam preferably with nitrile butadiene rubber modified by adding an expansion agent.

Prior to the application of surface layer 104 on the top rubber surface 114 of the base 102, the primer layer 106 is applied to the top rubber surface 114 to improve interlayer adhesion between the base 102 and the surface layer 104. An example of the primer in the primer layer 106 is a siloxane based primer with the main component being octamethyl trisiloxane (e.g., S11 NC commercially available from Henkel). In addition an inline corona treatment can be applied to the base 102 and/or primer layer 106 for further improved adhesion, as readily understood by a skilled artisan. Such inline corona treatments may increase the surface energy and adhesion of the imaging blanket layers.

FIG. 3 depicts another embodiment of an imaging blanket for a variable data lithography printing system according to embodiments. The imaging blanket is a multilayer blanket 200 having a base 202, a surface layer 204 and a primer layer 206 there between. The base 202 includes a seamless polyimide film 208 coated with a platinum cured silicone 210 (e.g., RT622 silicone, platinum cured siloxane, platinum cured fluorosilicone) at the interior of the imaging blanket as a multilayer carcass intentionally designed to support the surface (e.g., topcoat) layer 204. In this configuration, the polyimide film 208 provides support for the platinum cured silicone 210, and the platinum cured silicone provides the desired conformance to the printing surface of the surface layer 204. The platinum cured silicone or fluorosilicone has advantages for pot life, better control over cure kinetics, coating and durability due to better cross-linking. Without platinum curing, the silicone or fluorosilicone layer would start curing during coating.

The polyimide film 208 is a 20-80 μm thick seamless polyimide (PI) film that may be mounted on a mandrel. To further ensure a coupling of the PI film and the platinum cured silicone 210, a thin layer of primer 212 (e.g., vinyl terminated alkoxysilane, Wacker G790 primer) may be applied on the surface of the PI film using, for example, a brush or other coating applicator. While not being limited to a particular theory, the primer 212 may be applied for 1-2 hours at room temperature and 40-60% humidity. No pretreatment of PI film and no wiping of primer excess are required.

The platinum-cured silicone 210 may be a platinum cured siloxane having 8-10 mass parts of platinum cured siloxane to 1 part of cross-linker (premixed with platinum-catalyst and iron oxide particles), and 4-5 parts of a solvent (e.g., methyl isobutyl ketone (MIBK)), with a final viscosity of about 15000-20000 cPs. While not being limited to a particular theory, the platinum-cured silicone is applied, for example, flow coated on the surface of the PI film 208 functionalized with the primer 212.

Similar to the top rubber surface 114 of FIG. 1, the platinum-cured silicone 210 can be either treated with a primer (e.g., S11 commercially available from Henkel) and/or have an inline corona treatment that helps improve the adhesion of the surface layer 204 to the platinum-cured silicone surface.

Fluorosilicone with dispersed carbon black particles as the infrared (IR) filler has been used in an imaging plate/blanket 104 (FIG. 1) or 204 (FIG. 2). However, blankets made using the certain fluorosilicone formulations have poor print performance in fixture testing. The ink has poor adhesion for the blanket and does not properly wet the blanket. This results in low image density and holes (ink dewetting) in solid image patches. Disclosed herein is an improved formulation for an imaging blanket that yields blanket surface showing improved ink adhesion and ink wetting.

In the embodiments, the blanket 104 or 204 is manufactured from a first part and a second part. The first part (Part A) may include fluorosilicone, an IR absorbing filler, silica and a solvent. The second part (Part B) may include a platinum catalyst having vinyl groups, a cross-linker having hydrosilane groups, a solvent and an inhibitor. The ratio molar ratio of vinyl groups to hydrosilane groups in Part B is 1:1.

The fluorosilicone of part A may include a vinyl terminated trifluoropropyl methylsiloxane polymer (e.g., Wacker 50330, SML (n=27)) and is illustrated below in Formula 1.

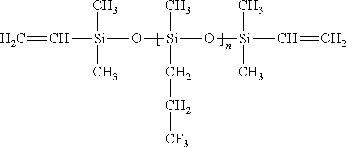

where n can be in range from 10 to 100, or from 15 to 90 or from 18 to 80.

In embodiments, the IR absorbing filler of Part A may be carbon black, a metal oxide such as iron oxide (FeO), carbon nanotubes, graphene, graphite, or carbon fibers. The IR absorbing filler may have an average particle size of from about 2 nanometers (nm) to about 10 μm. In an embodiment, the IR absorbing filler may have an average particle size of from about 20 nm to about 5 μm. In another embodiment, the filler has an average particle size of about 100 nm. In embodiments, the IR absorbing filler is carbon black. In an embodiment, the IR absorbing filler is a low-sulphur carbon black, such as Emperor 1600 (available from Cabot). In an embodiment, a sulphur content of the carbon black is 0.3% or less. In an embodiment, the sulphur content of the carbon black is 0.15% or less.

In embodiments, the Part A includes silica. For example, in one embodiment, the Part A includes between 1 weight percent and 5 weight percent silica based on the total weight of the surface layer composition. In another embodiment, the surface layer includes between 1 weight percent and 4 weight percent silica. In yet another embodiment, the surface layer includes about 1.15 weight percent silica based on the total weight of the surface layer composition. The silica may have an average particle size of from about 10 nm to about 0.2 μm. In one embodiment, the silica may have an average particle size of from about 50 nm to about 0.1 μm. In another embodiment, the silica has an average particle size of about 20 nm.

In embodiments, the solvent of Part A may be butyl acetate, trifluorotoluene toluene, benzene, methylethylketone, methyl isobutyl ketone, ethyl acetate, propyl acetate, amyl acetate, hexyl acetate and mixtures thereof.

Part B may include a platinum catalyst having vinyl groups. The platinum (Pt) catalyst is illustrated in Formula 2 below.

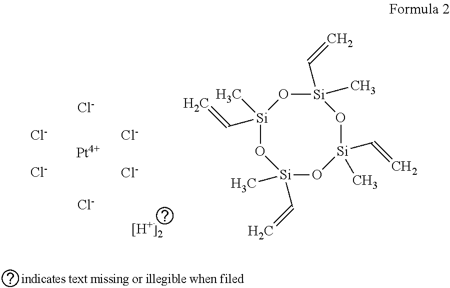

As shown in Formula 1, the platinum catalyst has vinyl groups.

Part B includes a cross-linker (e.g., trifluoropropyl methylsiloxane polymer having hydrosilane groups). In some embodiments, the surface layer composition includes fluorosilicone cross-linker. In one embodiment, the cross-linker is a XL-150 cross-linker from NuSil Corporation. In one embodiment, the cross-linker is a SLM 50336 cross-linker from Wacker. For example, in one embodiment, the surface layer composition includes between 10 weight percent and 28 weight percent of a cross-linker based on the total weight of the surface layer composition. In another embodiment, the surface layer includes between 12 weight percent and 20 weight percent cross-linker. In yet another embodiment, the surface layer includes about 15 weight percent cross-linker based on the total weight of the surface layer composition.

A cross-linker having hydrosilane groups is illustrated in Formula 3 below.

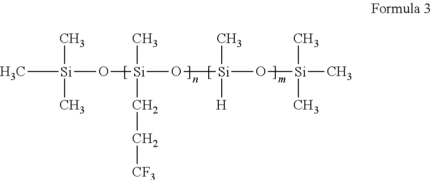

As shown in Formula 3, the cross-linker has hydrosilane groups. In Formula 3 n is from 10 to 100, or n is from 15 to 90, or n is from 18 to 80; and m is from 1 to 50, or m is from 2 to 45 or m is from 3 to 40. The molar ratio of vinyl groups in Part A to hydrosilane groups in the cross-linker in Part B is 0.7:1.0 to about 1.3:1.0, or a molar ratio of from 0.8:1.0 to about 1.2:1.0, or the molar ratio is from about 0.9:1.0 to about 1.1:1.0.

The inhibitor (pt88) may be used in the solution to increase the pot life of the combined solution of Part A and Part B for flow coating.

In embodiments, the solvent of Part B may be butyl acetate, trifluorotoluene, toluene, benzene, methylethylketone, methyl isobutyl ketone, ethyl acetate, propyl acetate, amyl acetate, hexyl acetate and mixtures thereof.

The surface layer 104 (FIG. 2) or 204 (FIG. 3) may be coated about the base. Some embodiments contemplate methods of manufacturing the imaging member surface layer 104 (FIG. 2) or surface layer 204 (FIG. 3). For example, in one embodiment, the method includes depositing a fluorosilicone surface layer composition upon a multilayer base by flow coating, ribbon coating or dip coating; and curing the surface layer at an elevated temperature.

In embodiments, the platinum catalysts is added to Part A followed by gentle shaking. Then Part B is added to the Part A solution containing Pt catalyst followed by 5 min of ball milling. The total solid content was controlled by dilution with additional amount of butyl acetate. The dispersion was filtered to remove the stainless steel beads, followed by degassing of the filtered dispersion. The dispersion was then coated over the multilayer base and primer layer. The dispersion could also be molded.

The curing may be performed at an elevated temperature of from about 140° C. to about 180° C. This elevated temperature is in contrast to room temperature. The curing may occur for a time period of from about 2 to 6 hours. In some embodiments, the curing time period is between 3 to 5 hours. In one embodiment, the curing time period is about 4 hours.

Aspects of the present disclosure may be further understood by referring to the following examples. The examples are illustrative, and are not intended to be limiting embodiments thereof. Example 1 illustrates the process of making a fluoroelastomer according to one embodiment of the present disclosure.

Specific embodiments will now be described in detail. These examples are intended to be illustrative, and not limited to the materials, conditions, or process parameters set forth in these embodiments. All parts are percentages by solid weight unless otherwise indicated.

### Examples

The following formulation was prepared.

Part A was prepared with a roll milling process to homogenously mix the vinyl terminated fluorosilicone, carbon black, silica and butyl acetate. A dispersant was added to improve the stability and dispersion quality of carbon black in fluorosilicone polymer.

Part B was prepared by gentle mixing of fluorsilicone containing hydrosilane groups (Wacker cross-linker SLM 50336) butyl acetate and an Inhibitor. The cross-linker solution was prepared by addition of proper amounts of cross-linker so as to yield the desired vinyl group to hydrosilane group molar ratio upon mixing Part A and Part B.

When the rolling process for part A was completed, the Pt catalyst was added to Part A followed by 5 min of gentle shaking. Then the Part B cross-linker solution was added to the Part A solution containing platinum catalyst, followed by 5 min of roll milling. The dispersion was filtered through a filter fabric to remove stainless steel beads, followed by degassing in a vacuum desiccator for 5 min. The dispersion was then coated on Trelleborg substrate using a 003 mil drawbar. The coating was then air dried for up to 1 hour and was then heated 160° C. for 4 hour to finish curing.

Imaging members with different coating compositions were print tested using magenta UV curable ink. Table 1 lists the optical densities of 100% solid fill print patches. Reducing the amount of cross-linker in the formulation significantly improved optical density of prints. Target optical density is around 1.4. This is shown in Table 1.

TABLE 1

| Molar Ratio between Vinyl groups in | |
|---|---|
| Part A:Hydrosilane (Silicon hydride) | Solid Area Optical |
| groups in Part B | Density |
| 0.5 | 1 |
| 0.7 | 1.1 |
| 0.9 | 1.4 |
| 1 | 1.5 |
| 1.1 | 1.4 |

Improvements in solid area optical density appear when the molar ratio of vinyl group to silicon hydride groups rises to at least 0.7

It will be appreciated that variants of the above-disclosed and other features and functions or alternatives thereof may be combined into other different systems or applications. Various presently unforeseen or unanticipated alternatives, modifications, variations, or improvements therein may be subsequently made by those skilled in the art, which are also encompassed by the following claims

What is claimed is:

1. A transfer member for use in a printer, comprising:
a fluorosilicone surface layer, the surface layer formed by a process comprising:
combining a first part and a second part, the first part comprising a vinyl terminated trifluoropropyl methylsiloxane, an IR absorbing filler, silica and a first solvent, and the second part comprising an organo platinum complex having vinyl groups, a methyl hydrosiloxanetrifluoropropyl methyl siloxane having hydrosilane groups an inhibitor and a second solvent, wherein a molar ratio of the vinyl groups to the hydrosilane groups is about 0.7:1.0 to about 1.3:1.0;
coating the first part and the second part on a substrate; and
curing the coating to form the fluorosilicone surface layer.

2. The transfer member according to claim 1, wherein the first solvent is selected from the group consisting of: butyl acetate, trifluorotoluene, toluene, benzene, methylethylketone, methyl isobutyl ketone, ethyl acetate, propyl acetate, amyl acetate, hexyl acetate and mixtures thereof.

3. The transfer member according to claim 1, wherein the second solvent is selected from the group consisting of: butyl acetate, trifluorotoluene, toluene, benzene, methylethylketone, methyl isobutyl ketone, ethyl acetate, propyl acetate, amyl acetate, hexyl acetate and mixtures thereof.

4. The transfer member according to claim 1, wherein the IR absorbing filler is selected from the group consisting of: carbon black, carbon nanotubes and metal oxides.

5. The transfer member according to claim 1, wherein the IR absorbing filler has an average particle size of from about 2 nanometers to about 10 microns.

6. The transfer member according to claim 1, wherein the silica has an average particle size from about 10 nanometers to about 0.2 microns.

7. A multilayer imaging blanket for a variable data lithography printing system, the multilayer imaging blanket comprising:
a multilayer base having a lower contacting surface configured to wrap around a printing cylinder of the variable data lithography printing system; and
a fluorosilicone surface layer coated and cured about the multilayer base, the fluorosilicone surface layer including a first part and a second part,
the first part comprising a vinyl terminated trifluoropropyl methylsiloxane, an IR absorbing filler and silica,
the second part comprising an organo platinum complex having vinyl groups, a methyl hydrosiloxanetrifluoropropyl methyl siloxane having hydrosilane groups and an inhibitor wherein a molar ratio of vinyl groups to hydrosilane groups is about 0.7:1.0 to about 1.3:1.0.

8. The multilayer imaging blanket according to claim 7, wherein the IR absorbing filler is selected from the group consisting of: carbon black, carbon nanotubes and metal oxides.

9. The multilayer imaging blanket according to claim 7, wherein the IR absorbing filler has an average particle size of from about 2 nanometers to about 10 microns.

10. The multilayer imaging blanket according to claim 7, wherein the silica has an average particle size from about 10 nanometers to about 0.2 microns.

11. The multilayer imaging blanket according to claim 7, further comprising a primer layer disposed between the multilayer base and the fluorosilicone surface layer.

12. The multilayer imaging blanket according to claim 7, wherein the multilayer base includes a seamless polyimide substrate.

13. A variable data lithography system, comprising:
a multilayer imaging blanket including: a multilayer base having a lower contacting surface configured to wrap around a printing cylinder of the variable data lithography printing system, a platinum catalyzed fluorosilicone surface layer coated about the multilayer base wherein the fluorosilicone surface layer coated and cured about the multilayer base, wherein the fluorosilicone surface layer includes a first part and a second part;
the first part comprising a vinyl terminated trifluoropropyl methylsiloxane, an IR absorbing filler and silica,
the second part comprising an organo platinum complex having vinyl groups, a methyl hydrosiloxanetrifluoropropyl methyl siloxane having hydrosilane groups and an inhibitor wherein a molar ratio of vinyl groups to hydrosilane groups is about 0.7:1.0 to about 1.3:1.0; and
a primer layer between the multilayer base and the fluorosilicone surface layer;
a fountain solution subsystem configured for applying a layer of fountain solution to the multilayer imaging blanket;
a patterning subsystem configured for selectively removing portions of the fountain solution layer so as to produce a latent image in the fountain solution;
an inking subsystem configured for applying ink over the imaging blanket such that said ink selectively occupies regions of the imaging blanket where fountain solution was removed by the patterning subsystem to thereby produce an inked latent image; and
an image transfer subsystem configured for transferring the inked latent image to a substrate.

14. The variable data lithography system according to claim 13, wherein the IR absorbing filler is selected from the group consisting of: carbon black, carbon nanotubes and metal oxides.

15. The variable data lithography system according to claim 13, wherein the IR absorbing filler has an average particle size of from about 2 nanometers to about 10 microns.

16. The variable data lithography system according to claim 13, wherein the silica has an average particle size from about 10 nanometers to about 0.2 microns.

17. The variable data lithography system according to claim 13, further comprising a primer layer disposed between the multilayer base and the fluorosilicone surface layer.

18. The variable data lithography system according to claim 13, wherein the multilayer base includes a seamless polyimide substrate.

19. The variable data lithography system according to claim 13, wherein the molar ratio of vinyl groups to hydrosilane groups is about 0.8:1.0 to about 1.2:1.0.

20. The variable data lithography system according to claim 13, wherein the molar ratio of vinyl groups to hydrosilane groups is about 0.9:1.0 to about 1.1:1.0.
